(19) United States
(12) Patent Application Publication
(10) Pub. No.: US 2007/0214386 A1
(43) Pub. Date: Sep. 13, 2007

(54) Computer system, method, and computer readable medium storing program for monitoring boot-up processes

(75) Inventor: Izumi Watanabe, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/704,969

(22) Filed: Feb. 12, 2007

(30) Foreign Application Priority Data
Mar. 10, 2006 (JP) 2006-065698

(51) Int. Cl. G06F 11/00

(52) U.S. Cl. 714/13

(57) ABSTRACT

A computer system which comprises a first processor, a second processor, a first module apart from the first and second processors, and corresponding to a first test, and a failure processor is disclosed. In that system, the failure processor is constructed and arranged to separate the first module from the computer system when the first test fails when performed by the first processor and when performed by the second processor.

### BACKGROUND OF THE INVENTION

1. Field of the Invention

The present invention relates to a computer system, a method, and a computer readable medium storing a program for monitoring boot-up processes. Particularly, the present invention relates to a boot-up monitoring computer system, a boot-up monitoring method, and a boot-up monitoring program for handling failures occurring at boot-up processes and restarts.

2. Description of the Related Art

In a computer system, a method such as a watchdog timer is used as a stall monitoring means to handle failures that stop a system boot-up process (stall failure).

Specifically, when the stall monitoring means detects stall failures of a boot strap processor (a processor for conducting boot-up or initialize process for a system, hereinafter referred to as BSP) and determines that the failures are due to the BSP, the stall monitoring means performs a failure handling that separates the BSP and restarts the system with a different processor in the system as a new BSP.

In Japanese Patent Laid-Open No. 2005-18462 (See paragraphs 0019 to 0043 and FIG. 1), there is described a method for determining whether a cause of a stall failure is a processor or the other parts using a service processor in a computer system having a plurality of processors.

A quick handling of stall failures is required in order to reduce a downtime. For that purpose, it is preferable to handle failures taking a particular test, during which such failures occur, into consideration.

### SUMMARY OF THE INVENTION

According to the present invention, a failure analysis means performs failure-handling corresponding to a particular test during which failures occur in a boot-up or a restart process. Therefore, handling of failures can be performed properly and promptly.

In the present invention, the failure analysis means may be configured to, when failures occur in a test during a boot-up process, separate from the system a processor which performed a boot-up process and cause another processor in the system to perform a restart process. In this case, a handling of processor failures can be performed rapidly.

When a boot-up process and a restart process are performed by different processors respectively and when failures occur in the same test both during the boot-up process and the restart process, it is assumed that the failures are due to a module apart from the processors. Here a module means a hardware or software module in the computer system such as a memory, a harddisk, a keyboard, a software procedure, and other software information. Therefore, the failure analysis means may be configured to separate from the system the module corresponding to the test during which failures occurred when 1) a boot-up process and a boot-up process are performed by different processors respectively and 2) the failures occurred in, the same test both during the boot-up process and the restart process. In this case, a handling of failures due to a module apart from the processors can be performed rapidly.

Further, the failure analysis means may be configured to restart a system promptly after separating such a module from the system. In this case, a downtime of the computer system can be reduced.

When a boot-up process and a boot-up process are performed by different processors respectively and when failures occur in different tests during the boot-up process and the restart process, it is expected that a cause of the failures are complicated. Therefore, in this case, the failure analysis means may be configured to stop an operation of the system. Thereby, additional failures can be prevented.

According to a present invention, there is provided a computer system comprising a first processor, a second processor, a first module apart from the first and second processors, and corresponding to a first test, and a failure processor wherein the failure processor is constructed and arranged to separate the first module from the computer system when the first test fails when performed by the first processor and when performed by the second processor. Also there is provided a computer system further comprising a second module apart from the first processor, the second processor, and the first module, and corresponding to a second test wherein the failure processor is constructed and arranged to stop the computer system when the first processor and the second processor each fail respectively different tests.

According to a present invention, there is provided a method comprising separating, from a computer system, a first module in the computer system which is different and apart from a first and a second processor in the computer system when a first test corresponding to the first module fails when performed by the first processor and when performed by the second processor. Also there is provided a method, further comprising performing, by the first processor and by the second processor, a second test corresponding to a second module in the computer system which is different and apart from the first processor, the second processor and the first module in the computer system and stopping the computer system when the test-which fails performed by the first processor and the test which fails performed by the second processor are different.

According to a present invention, there is provided a computer readable medium storing thereon a control program enabling a computer to execute one of the methods described above.

### BRIEF DESCRIPTION OF THE DRAWINGS

This above-mentioned and other objects, features and advantages of this invention will become more apparent by reference to the following detailed description of preferred embodiment of the invention taken in conjunction with the accompanying drawings, wherein:

FIG. 1 is a block diagram which shows a configuration of a computer system according to an embodiment of -the present invention;

FIG. 2 is a flowchart which illustrates an operation during a boot-up process of a computer system;

FIG. 3 is an explanatory diagram of information which represents actions that are performed if a stall failure occurs during restart process;

FIG. 4 is a flowchart which illustrates an operation in a case that a stall failure occurs in the same POST as in a boot-up process when the computer system is restarted; and

FIG. 5 is a flowchart which illustrates an operation in a case that a stall failure occurs in a different POST from that in a boot-up process when the computer system 1 is restarted.

### DETAILED DESCRIPTION OF THE INVENTION

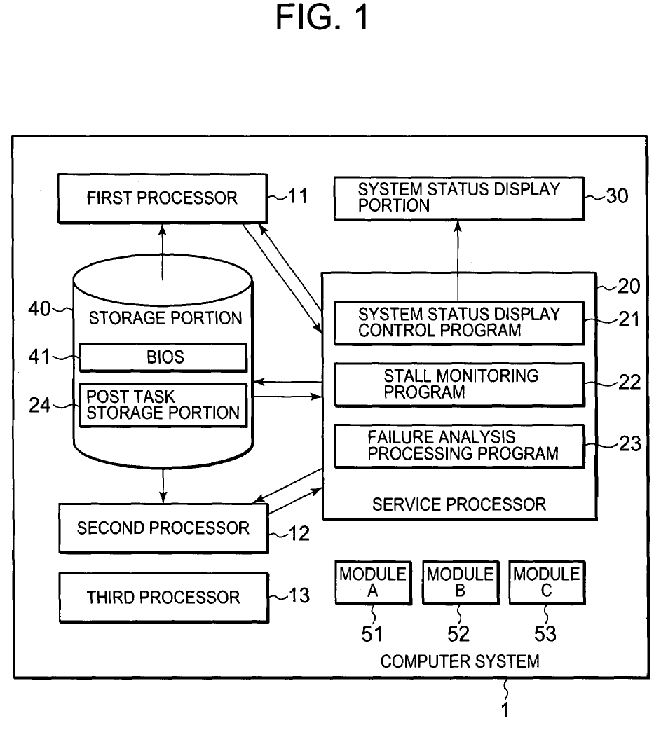

An embodiment of the present invention will be described with reference to the drawings. FIG. 1 is a block diagram which shows a configuration example of a computer system 1 of an embodiment of the present invention.

The computer system 1 is a computer system having a plurality of processors. The computer system 1 includes a first processor 11, a second processor 12, and a third processor 13. The first processor 11 starts the computer system 1. The second processor 12 can restart the computer system 1 if a stall failure occurs at a boot-up process of the computer system 1 by the first processor 11. The third processor 13 can restart the computer system 1 if a stall failure occurs at a boot-up process of the computer system 1 by the second processor 12. The computer system 1 further includes a service processor 20 for monitoring a boot-up and a restart of the computer system 1, a system status display portion 30 for displaying an execution status of a Power On Self Test (POST), and a storage portion (storage means) 40 for storing information.

A POST means a test for checking if there is a failure in hardware or software module in the computer system 1 such as a memory, a hard disk, a keyboard, a software procedure, and other software information during a boot-up process and a restart process of the computer system 1. When the computer system 1 is started or restarted, a plurality of types of POST (For example, a first POST, a second POST, and a third POST) is performed. A POST succeeds when a test for corresponding hardware or software modules ends detecting no failures. A POST fails when a stall failure is detected during the test.

Though the computer system 1 shown in FIG. 1 has 4 processors, i.e., the first processor 11, the second processor 12, the third processor 13, and the service processor 20, the number of processors which the computer system 1 has is not limited to four. In other words, the computer system 1 may have more than 4 processors (such as a fifth processor and a sixth processor). Also the computer system may not have the third processor 13.

Additionally, although it is not shown that the third processor 13 is connected to the service processor 20 and the storage portion 40 in FIG. 1, the third processor 13 is connected to the service processor 20 and the storage portion 40 in case a stall failure occurs when the computer system 1 is started-up or restarted by the second processor 12.

The first processor 11, the second processor 12, and the third processor 13 operate according to a program implemented in the computer system 1.

The storage portion 40 stores a Basic Input/Output System (BIbS) 41. In addition, the storage portion 40 includes a POST task storage portion 24. The POST task storage portion 24 stores, 1) a content of each of a plurality of predetermined POSTs that are performed during a boot-up process and a restart process of the computer system 1, 2) a POST code which indicates a POST in which a stall failure occurs, 3) information which indicates a module suspected to have caused a stall failure, and 4) information which indicates a process that is to be performed after a stall failure occurs (handling instruction information). The content of each POST includes, for example, description of tests to be performed for the POST, a corresponding module which is tested in the POST and suspected to cause a stall failure during execution of the POST, and a process that is to be performed when a stall failure occurs during execution of the POST. The POST task storage portion 24 may store each type of information in a table format.

The handling instruction information stored in the POST task storage portion 24 is, for example, information indicating a process to separate from the computer system 1 a processor or a module that is suspected to have caused a failure and restart the computer system 1, or information indicating a process to stop a boot-up process of the computer system 1.

More particularly, the handling instruction information may include, for example, information which indicatesaprocess to initialize a module A 51 in the computer system 1 and stop the operation of the computer system 1 when a stall failure occurs in the first POST during a restart process.

In addition, the handling instruction information may include, for example, information which indicates a process to, when a stall failure occurs in the second POST during a restart process, initialize a module B 52, separate or disconnect the module B 52 from the computer system 1, and cause the second processor 12 or the third processor 13 to restart the computer system 1.

In addition, the handling instruction information may include, for example, information which indicates a process to, when a stall failure occurs in the third POST during a restart process, initialize a module C 53, separate it from the computer system 1, and cause the second processor 12 or the third processor 13 to restart the computer system 1.

The service processor 20 includes a system status display control processing program 21, a stall monitoring processing program 22, and a failure analysis processing program 23.

The system status display control processing program 21 is a program for the service processor 20 to output information which indicates an execution status of a POST to-the system status display portion 30. The stall monitoring processing program 22 is a program for the service processor 20 to monitor a boot-up process and a restart process of the computer system 1 which are performed by the first processor 11, the second processor 12, or the third processor 13.

Specifically, the stall monitoring processing program 22 causes the service processor 20 to do the following:

1) to start time measurement when the service processor 20 receives a monitoring start notification from the first processor 11, the second processor 12, or the third processor 13,
2) to determine that a stall failure occurred during a boot-up process and restart process in the first processor 11, the second processor 12, or the third processor 13, if a monitoring completion notification to indicate a completion of monitoring is not received within a predetermined time (for example, within 30 seconds) from the processor performing the process.

The failure analysis processing program 23 causes the service processor 20 to handle a stall failure according to handling instruction information stored in the POST task storage portion 24 if the stall failure occurs when the computer system 1 is started or restarted by the first processor 11, the second processor 12, or the third processor 13.

For example, if a stall failure occurs when the computer system 1 is started by the first processor 11, the failure analysis processing program 23 causes the service processor 20 to separate or disconnect the first processor 11 from the computer system 1 and to cause the second processor 12 to restart the computer system 1.

In addition, for example, if a stall failure occurs in the first POST during a restart process, the failure analysis processing program 23 causes the service processor 20 to initialize the module A 51 in the computer system 1 and stop the operation of the computer system 1.

In addition, for example, if a stall failure occurs in the second POST at a restart process, the failure analysis processing program 23 causes the service processor 20 to initialize the module B 52 in the computer system 1 and separate or disconnect it from the computer system 1 and to cause the second processor 12 or the third processor 13 to restart the computer system 1.

In addition, for example, if a stall failure occurs in the third POST during a restart process, the failure analysis processing program 23 causes the service processor 20 to initialize the module C 53 in the computer system 1 and separate it from the computer system 1 and causes the second processor 12 or third processor 13 to restart the computer system 1.

Each module to be initialized and separated from the computer system 1 when a stall failure occurs in the second POST or the third POST is, for example, one of a plurality of I/O controller modules on a mother board in the computer system 1. These modules are physically separate or apart from each of the processors.

The first processor 11, the second processor 12, or the third processor 13 reads the BIOS 41 stored in the storage portion 40 to start the computer system 1. Then, the first processor 11, the second processor 12, or the third processor 13 outputs a monitoring start notification to request a start of monitoring to the service processor 20 at the beginning of a boot-up process or a restart process of the computer system In addition, the first processor 11, the second processor 12, or the third processor 13 outputs a monitoring completion notification to indicate an end of monitoring to the service processor 20 at the end of a boot-up process or a restart process of the computer system 1.

The boot-up monitoring means is implemented by, for example, the stall monitoring program 22 executed by the service processor 20 of the computer system 1. The failure analysis means is implemented by, for example, the failure analysis processing program 23 executed by the service processor 20 of the computer system 1.

In addition, the computer system 1 may also includes a boot-up monitoring program for performing both of the following boot-up monitoring process and failure analysis process in the service processor 20.

1) In the boot-up monitoring process, the service processor 20 monitors a boot-up process and a restart process of the computer system 1 performed by the first processor 11 or the second processor 12, and determines a test during which a failure occurs among a plurality of predetermined tests (POSTs) that are performed during the boot-up process and the restart process.
2) If the service processor 20 determines that a failure occurs in any of the plurality of predetermined tests performed during a boot-up process and a restart process of the computer system 1 in the boot-up monitoring process, the service processor 20 handles the failure, in the failure analysis process, based on (1) a test performed when a failure occurs in the boot-up process, (2) a test performed when a failure occurs in the restart process, and (3) handling instruction information stored in the POST task storage portion 24.

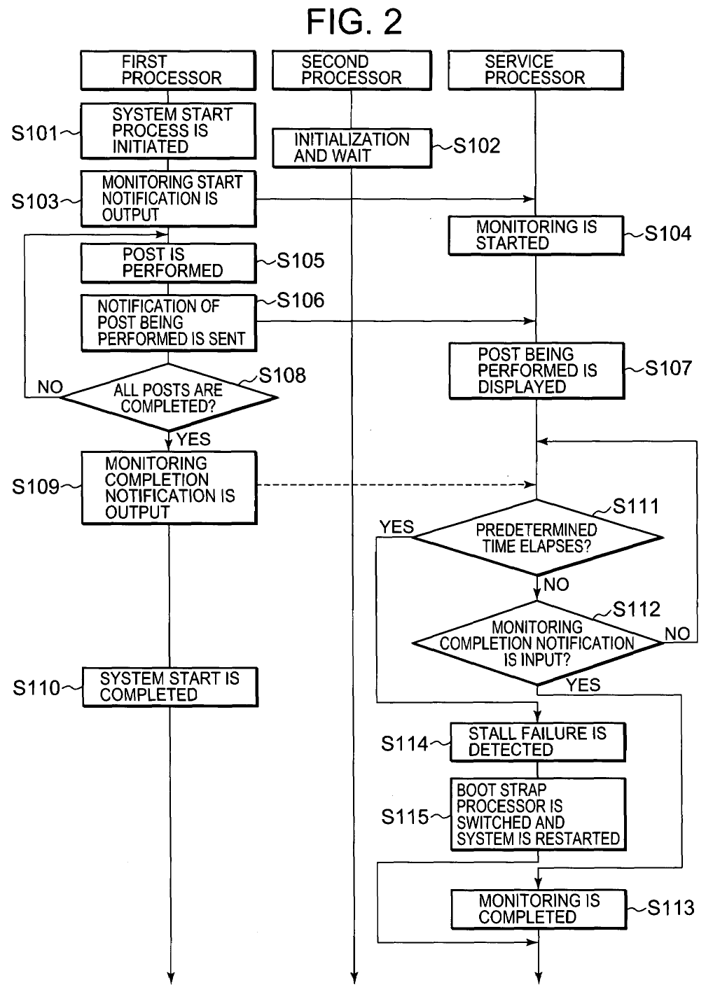

The operation of the computer system 1 of an embodiment of the present invention will now be described. As shown in FIG. 2, when the computer system 1 is given an instruction for boot-up, the first processor 11 initiates a boot-up process of the computer system 1 (step S101), and the second processor 12 is initialized and waits for an instruction or the like from the service processor 20 (step S102).

The first processor 11 outputs a monitoring start notification to the service processor 20 (step S103). The service processor 20 receiving the monitoring start notification executes the stall monitoring processing program 22 to start monitoring of the first processor 11 (step S104) Specifically, the service processor 20 starts time measurement.

The first processor 11 reads and executes the BIOS 41 stored in the storage portion 40, and therefore reads contents of POSTs stored in the storage portion 40 and performs each POST (step S105).

The first processor 11, notifies the service processor 20 of a POST which the first processor 11 is performing (step S106). The service processor 20 executes the system status display control program 21 to display the POST which the first processor 11 is performing on the system status display portion 30 (step S107).

The first processor 11 performs each POST and sends a notification of the POST that is being performed to the service processor 20 until all predetermined POSTs are completed (step S105, step S106, and No at step S108).

When all the predetermined POSTs are completed (Yes at step S108), the first processor 11 outputs a monitoring completion notification to the service processor 20 (step S109), and completes the boot-up process of the computer system 1 (step S110).

In the example shown in FIG. 2, the output of the monitoring completion notification is represented by an arrow with dashed line since the monitoring completion notification is output only when all predetermined POSTs are completed and is not output when a stall failure occurs in any of POSTS.

If the monitoring completion notification is input (Yes at step S112) before a predetermined time,has elapsed (No at step S111), the service processor 20 ends monitoring of the boot-up of the computer system 1 (step S113).

If the predetermined time has elapsed without an input of the monitoring completion notification (Yes at step S111), the service processor 20 detects that a stall failure occurred during the boot-up process by the first processor 11 (step S114).

The service processor 20 executes the failure analysis processing program 23 to store a POST code indicating a POST during which the stall failure occurred in the storage portion 40. In addition, the service processor 20 separates or disconnects the first processor 11 from the computer system 1 and uses the second processor 12 to restart the computer system 1 based on the output of the failure analysis processing program 23 (step S115).

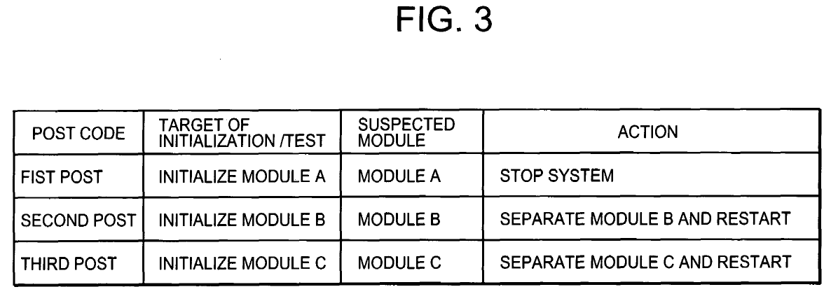

An operation during a restart process of the computer system 1 will now be described. FIG. 3 is an explanatory diagram of information which shows actions to be performed if a stall failure occurs during a restart process, and this information is stored in the POST task storage portion 24.

In the example of the POST task storage portion 24 shown in FIG. 3, when a stall failure occurs in the first POST during a restart process, the failure analysis processing program 23 causes the service processor 20 to initialize the module A 51 in the computer system 1 and stop the operation of the computer system 1.

In the same example, when a stall failure occurs in the second POST at a restart process, the failure analysis processing program 23 causes the service processor 20 to initialize the module B 52 in the computer system 1 and separate or disconnect the module B 52 from the computer system 1, and causes the first processor 11, the second processor 12, or the third processor 13 to restart the computer system 1.

Further, in the same example, when a stall failure occurs in the third POST at a restart process, the failure analysis processing program 23 causes the service processor 20 to initialize the module C 53 in the computer system 1 and separate or disconnect the module C 53 from the computer system 1, and causes the first processor 11, the second processor 12, or the third processor 13 to restart the computer system 1.

Note that each POST may correspond to a plurality of modules, for example modules A and B.

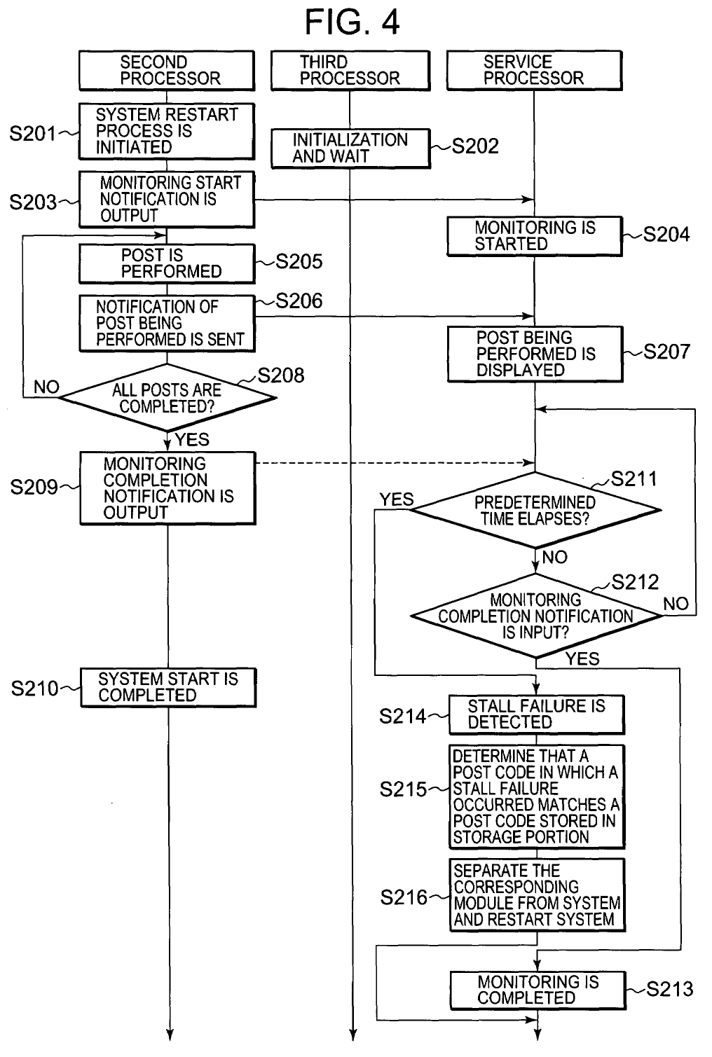

FIG. 4 is a flowchart which illustrates an operation in a case that a stall failure occurs in the same POST as in the boot-up process when the computer system 1 is restarted.

When the service processor 20 restarts the computer system 1 using the second processor 12, the second processor 12 initiates a restart process of the computer system 1 (step S201), and the third processor 13 is initialized and waits for an instruction or the like from the service processor 20 (step S202).

The second processor 12 outputs a monitoring start notification to the service processor 20 (step S203). The service processor 20 receiving the monitoring start notification executes the stall monitoring processing program 22 to start monitoring of the second processor 12 (step S204). Specifically, the service processor 20 starts time measurement.

The second processor 12 reads and executes the BIOS 41 stored in the storage portion 40, and therefore reads contents of POSTs stored in the storage portion 40 and performs each POST (step S205).

The second processor 12 notifies the service processor 20 of a POST which the second processor 12 is performing (step S206). The service processor 20 executes the system status display control program 21 to display the POST which the second processor 12 is performing on the system status display portion 30 (step S207).

The second processor 12 performs each POST and a notification of a POST that is being performed is sent to the service processor 20 until all predetermined POSTs are completed (step S205, step S206, and No at step S208).

When all the predetermined POSTs are completed (Yes at step S208), the second processor 12 outputs a monitoring completion notification to the service processor 20 (step S209), and completes the boot-up process of the computer system 1 (step S210).

In the example shown in FIG. 4, the output of the monitoring completion notification is represented by an arrow with dashed line since the monitoring completion notification is output only when all predetermined POSTs are completed and is not output when a stall failure occurs in any of POSTs.

If the monitoring completion notification is input (Yes at step S212) before the predetermined time has elapsed (No at step S211), the service processor 20 ends monitoring of the start of the computer system 1 (step S213).

If the predetermined time has elapsed without an input of the monitoring completion notification (Yes at step S211), the service processor 20 detects that a stall failure occurred during the restart process by the second processor 12 (step S214).

The service processor 20 executes the failure analysis processing program 23 to determine that a POST that is being performed by the second processor 12 matches a POST code stored in the storage portion 40 which indicates a POST during which a failure occurred at the first processor (step S215). In addition, the service processor 20 stores a code which indicates a POST in which a stall failure occurred at the second processor in the storage portion 40.

When a stall failure occurs when the same POST is performed in the boot-up process illustrated in the flowchart of the FIG. 2 and in the a restart process illustrated in the flowchart of the FIG. 4, a module Corresponding to the POST that was being performed when the stall failure occurred is suspected to cause the stall failure, not the processor. Thus, the module may be removed or separated from the computer system 1.

Therefore, if a POST performed by the second processor 12 matches a POST code stored in the storage portion 40, the service processor 20 determines that the stall failure has occurred due to something apart from the processors. Then, the service processor 20 identifies a part or module which is corresponding to the POST in which the failure has occurred by reference to the handling instruction information stored in the storage portion 40, separates or disconnects the part or module, and causes the second processor 12 to restart the computer system 1 (step S216).

Particularly, if a stall failure occurs when the second POST is performed both in the boot-up process illustrated in the flowchart of the FIG. 2 and the a restart process illustrated in the flowchart of the FIG. 4, the service processor 20 initializes the module B 52 based on the output of the failure analysis processing program 23, separates or disconnects the module B 52 from the computer system 1, and causes the second processor 12 to restart the computer system 1 as shown in FIG. 3.

When the computer system 1 is restarted and successful in the restart, the module can be identified as a cause of the stall failure.

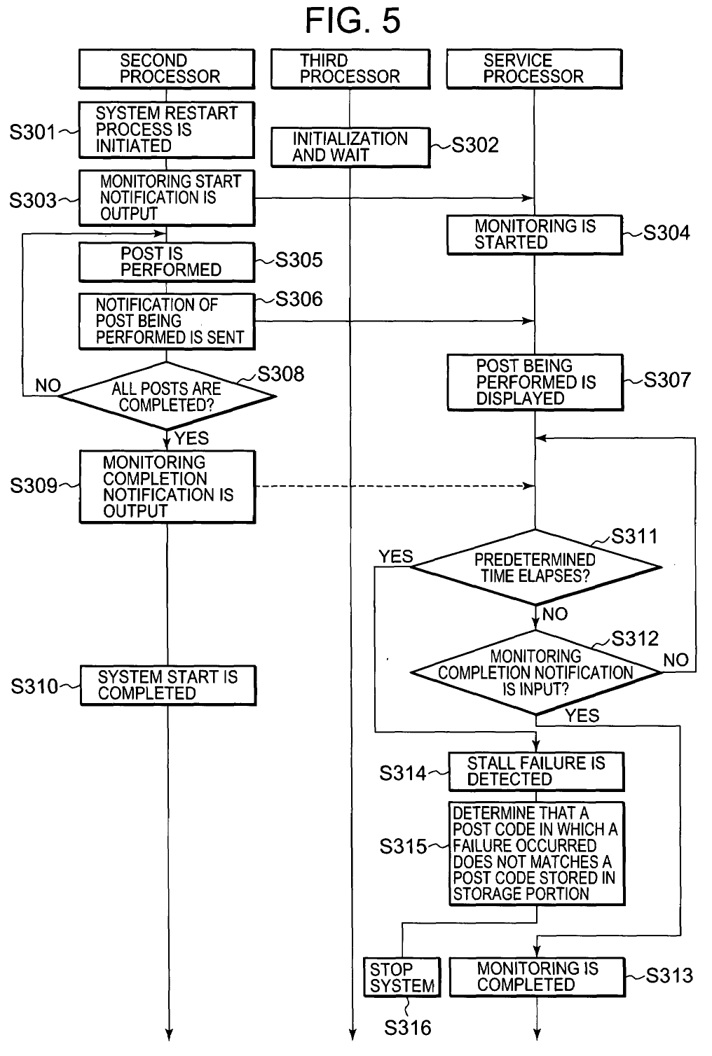

FIG. 5 is a flowchart which illustrates an operation in a case that a stall failure occurs in a different POST from that during a boot-up process when the computer system 1 is restarted.

When the service processor 20 restarts the computer system 1 using the second processor 12, the second processor 12 initiates a restart process of the computer system 1 (step S301), and the third processor 13 is initialized and waits for an instruction or the like from the service processor 20 (step S302).

The second processor 12 outputs a monitoring start notification to the service processor 20 (step S303). The service processor 20 receiving the monitoring start notification executes the stall monitoring processing program 22 to start monitoring of the second processor 12 (step S304). Specifically, the service processor 20 starts time measurement.

The second processor 12 reads and executes the BIOS 41 stored in the storage portion 40, and therefore reads contents of POSTs stored in the storage portion 40 and performs each POST (step S305).

The second processor 12 notifies the service processor 20 of a POST which the second processor 12 is performing (step S306). The service processor 20 executes the system status display control program 21 to display the POST which the second processor 12 is performing on the system status display portion 30 (step S307).

The second processor 12 performs each POST and a notification of a POST that, is being performed is sent to the service processor 20 until all predetermined POSTs are completed (step S305, step S306, and No at step S308).

When all the predetermined POSTs are completed (Yes at step S308), the second processor 12 outputs a monitoring completion notification to the service processor 20 (step S309), and completes the restart process of the computer system 1 (step S310).

In the example shown in FIG. 5, the output of the monitoring completion notification is represented by an arrow with dashed line since the monitoring completion notification is output only when all predetermined POSTs are completed and is not output when a stall failure occurs in any of POSTs.

If the monitoring completion notification is input (Yes at step S312) before a predetermined time has elapsed (No at step S311), the service processor 20 ends monitoring of the restart of the computer system 1 (step S313).

If the predetermined time has elapsed without an input of the monitoring completion notification (Yes at step S311), the service processor 20 detects that a stall failure occurred in the second processor 12 (step S314).

The service processor 20 executes the failure analysis processing program 23 to determine that a POST that is being performed by the second processor 12 does NOT match a POST code stored in the storage portion 40 which indicates a POST during which failures occurred at the first processor (step S315). In addition, the service processor 20 stores a code which indicates a POST during which a stall failure occurred at the second processor in the storage portion 40.

Then, when a POST being performed by the second processor 12 does not match a POST code stored in the storage portion 40, the service processor 20 determines that the stall failure has occurred due to a complicated cause depending on a component apart from the processors. Then, the service processor 20 determines that the operation of the compute system 1 is not possible and stops the boot-up of the computer system 1 (step S316).

If the monitoring completion notification is input (No at step S211 and Yes at step S212 in FIG. 3, No at step S311 and Yes at step S312 in FIG. 4) before the predetermined time has elapsed, the service processor 20 completes monitoring of the boot-up of the computer system 1 (step S213 in FIG. 3, step S313 in FIG. 4).

Then, since no stall failure occurs when the first processor 11 is separated, the service processor 20 identifies the first processor 11 as a cause of the stall failure.

In the operation illustrated by the flowchart of FIG. 4, since a POST in which a stall failure occurs during a boot-up process is the same as a POST in which a stall failure occurs at a restart process, a failure is handled depending on a POST during which a stall failure occurs.

On the other hand, in the operation illustrated by the flowchart of FIG. 5, since a POST in which a stall failure occurs during a boot-up process is different from a POST in which a stall failure occurs during a restart process, the operation of the computer system 1 is determined to be impossible, and boot-up of the computer system 1 is stopped.

According to the present embodiment, a cause of a stall failure can be identified because the service processor 20 monitors boot-up process of the computer system 1 from before to after a restart thereof.

Specifically, based on a POST in which a stall failure occurs during a boot-up process and a POST in which a stall failure occurs during a restart process, whether the stall failure occurs due to a platform including a module mounted on a mother board in the computer system 1 or a processor in the computer system 1 can be identified.

Further, when a POST in which a stall failure occurs during a boot-up process is the same as a POST in which a stall failure occurs at a restart process, a module or the like suspected to be a cause of a stall failure can be identified.

Then, since the module or the like suspected to be the cause of the stall failure is separated and the computer system 1 is restarted, the computer system 1 can be operated continuously.

In addition, according to the present embodiment, a cause of a stall failure can be identified so that maintainability can be improved and a downtime of the computer system 1 can be reduced.

What is claimed is:

1. A computer system comprising;
a first processor,
a second processor,
a first module apart from said first and second processors, and corresponding to a first test, and
a failure processor wherein said failure processor is constructed and arranged to separate said first module from the computer system when said first test fails when performed by said first processor and when performed by said second processor.

2. The computer system according to claim 1 further comprising
a second module apart from said first processor, said second processor, and said first module, and corresponding to a second test wherein said failure processor is constructed and arranged to stop the computer system when said first processor and said second processor each fail respectively different tests.

3. The computer system according to claim 1 further comprising
a second module apart from said first processor, said second processor, and said first module, and corresponding to a second test wherein said failure processor is constructed and arranged to separate from the computer system one of the first or second module which causes a system failure when corresponding tests are performed by said first processor and when performed by said second processor.

4. The computer system according to claim 1 wherein said failure processor is constructed and arranged to separate said first processor from the computer system when said first test fails when performed by said first processor and said first test succeeds when performed by said second processor.

5. A method comprising;
separating, from a computer system, a first module in said computer system which is different and apart from a first and a second processor in said computer system when a first test corresponding to said first module fails when performed by said first processor and when performed by said second processor.

6. The method according to claim 5, further comprising
performing, by said first processor and by said second processor, a second test corresponding to a second module in said computer system which is different and apart from said first processor, said second processor and said first module in said computer system and
stopping said computer system when the test which fails performed by said first processor and the test which fails performed by said second processor are different.

7. The method according to claim 5 further comprising
separating, from said computer system, a second module in said computer system which is different and apart from said first processor, said second processor and said first module in said computer system when a second test corresponding to said second module fails when performed by said first processor and when performed by said second processor.

8. The method according to claim 5 further comprising separating said first processor from said computer system when said first test fails when performed by said first processor and said first test succeeds when performed by said second processor.

9. A computer readable medium storing thereon a control program enabling a computer to execute said method according to claim 5.

10. A computer readable medium storing thereon a control program enabling a computer to execute said method according to claim 6.

11. A computer readable medium storing thereon a control program enabling a computer to execute said method according to claim 7.

12. A computer readable medium storing thereon a control program enabling a computer to execute said method according to claim 8.
